(19) United States
(12) Patent Application Publication
(10) Pub. No.: US 2025/0196160 A1
(43) Pub. Date: Jun. 19, 2025

(54) PRODUCTION PROCESS FOR ELECTROSTATIC DUST REMOVAL DEVICE

(71) Applicant: AirQuality Technology (Shanghai) Co., Ltd., Shanghai (CN)

(72) Inventors: Shanqing MENG, Shanghai (CN); Lisun WANG, Shanghai (CN); Shidan LONG, Shanghai (CN)

(21) Appl. No.: 19/012,086

(22) Filed: Jan. 7, 2025

Related U.S. Application Data
(63) Continuation of application No. PCT/CN2024/132610, filed on Nov. 18, 2024.

(30) Foreign Application Priority Data
Dec. 14, 2023 (CN) 2023117308220

(51) Int. Cl. B03C 3/47; B03C 3/08; B03C 3/70

(52) U.S. Cl. CPC B03C 3/47; B03C 3/08; B03C 3/70

(57) ABSTRACT

The present invention relates to a production process for an electrostatic dust removal device, and belongs to the technical field of air purification. The production process includes the following steps: S100: sequentially and alternately placing dust collection plates and spacers to form a mold core; S300: mounting fixed separators along fixed positions reserved on the dust collection plates, and dismantling the spacers; and S500: mounting an electric conductor at an end portion of the mold core, and performing insulation treatment on the end portion of the mold core through an insulation adhesive. According to the present invention, the technical problems of low production efficiency and increased input cost due to a tedious production process in the prior art can be solved.

### CROSS-REFERENCE TO RELATED APPLICATIONS

The present application claims priority to Chinese Patent Application No. 2023117308220, filed on Dec. 14, 2023, the entire disclosure of which is incorporated herein by reference.

### TECHNICAL FIELD

The present invention belongs to the technical field of air purification, and particularly relates to a production process for an electrostatic dust removal device.

### BACKGROUND

Currently, the mainstream technologies for air purification are divided into a filtration technology and an electrostatic technology. The filtration technology filters or adsorbs pollutants in the air through fibers and fiber-based filtering materials, thereby purifying the air. The technology is mature and relatively stable in operation. However, the labor cost, material cost, operation cost and maintenance cost are very high, and improper maintenance may pose certain safety risks. Due to the continuous interception of pollutants in the air by filter materials, the gaps between fibers are constantly blocked, and wind resistance is increasing. Therefore, frequent cleaning and replacement of filter materials are required. At the same time, bacteria and viruses in the air trapped in filter materials can cause the problems such as bacterial growth, mold growth, and odor. The electrostatic technology charges particulate matters in gas through ionization modules, and the charged particulate matters are adsorbed by the electric field formed by a dust collection module to complete purification. Various high-voltage electrostatic dust removal devices developed and designed using the principles of electrostatic technology can purify wide flow rate and complete particle pollution. The high-voltage electrostatic dust removal devices can achieve relatively stable use in environments such as different temperatures and humidities, and can be well applied to air filtration treatment in household, commercial, industrial, tunnel, subway and other fields. The high-voltage electrostatic dust removal devices have the technical characteristics of long service life, high purification efficiency, low operating costs, and low maintenance costs.

At present, most electrostatic dust removal devices have tedious production processes, resulting in low production efficiency and increased input cost. Therefore, it is necessary to develop a rapid production process for an electrostatic dust removal device.

### SUMMARY

In view of the shortcomings in the prior art, a production process for an electrostatic dust removal device is provided, so as to solve the technical problems of low production efficiency and increased investment cost due to a tedious production process in the prior art.

To achieve the foregoing objective, the present invention provides the following technical solutions:

a production process for an electrostatic dust removal device includes the following steps:
S100: sequentially and alternately placing dust collection plates and spacers to form a mold core;
S300: mounting fixed separators along fixed positions reserved on the dust collection plates, and dismantling the spacers; and
S500: mounting an electric conductor at an end portion of the mold core, and performing insulation treatment on the end portion of the mold core through an insulation adhesive.

This technical solution is further set as follows: in the step S100, the placing order of the dust collection plates and the spacers is adjustable, the dust collection plates comprise ground dust collection plates and high-voltage dust collection plates which are arranged in an alternately superimposed manner, the ground dust collection plates and the high-voltage dust collection plates are arranged in a 180° staggered manner, and the ground dust collection plates and the high-voltage dust collection plates have the same structure.

This technical solution is further set as follows: an insulation layer is arranged inside each of the dust collection plates, a semiconductor layer is arranged on two sides of the insulation layer, and a conductive layer is arranged between the insulation layer and the semiconductor layer.

This technical solution is further set as follows: a manufacturing method for each of the dust collection plates includes the following steps:
symmetrically printing the conductive layer on the two sides of the insulation layer, coating an adhesive layer after the conductive layer is dried, sticking or bonding the semiconductor layer on the adhesive layer, sticking or bonding the semiconductor layer on the conductive layer on the other side by the same method after flipping, and cutting or punching the dust collection plates meeting the design size requirements on equipment.

This technical solution is further set as follows: the thickness of the semiconductor layer of a dust collection layer dust collection plate is less than that of the non-dust collection layer dust collection plate.

This technical solution is further set as follows: a conductive layer is arranged inside each of the dust collection plates, and a semiconductor layer is arranged on two sides of the conductive layer.

This technical solution is further set as follows: in the step S100, a rod-shaped part is used to sequentially penetrate into the dust collection plate and process holes in the spacers to form the mold core.

This technical solution is further set as follows: in the step S100, insulation plates are arranged on two side surfaces of the mold core, the rod-shaped part is used to sequentially penetrate into the insulation plates, the dust collection plates and the process holes in the spacers and is fastened outside the insulation plates to form the mold core.

This technical solution is further set as follows: in the step S300, insulation adhesives are poured along the fixed positions reserved on the dust collection plates, and the fixed positions are arranged on edges of the dust collection plates.

This technical solution is further set as follows: in the step S300, rigid insulation parts are mounted along the fixed positions reserved on the dust collection plates, and dust collection plate seams for accommodating the dust collection plates are formed in the rigid insulation parts.

This technical solution is further set as follows: in the step S300, a rod-shaped part is dismantled, and the spacers are withdrawn from the end portion of the mold core.

This technical solution is further set as follows: the step S500 of mounting the electric conductor at the end portion of the mold core, and performing insulation treatment on the end portion of the mold core through the insulation adhesive specifically includes the following steps:
when the process holes are formed in two end portions of each of the dust collection plates, penetrating the rod-shaped part into the process holes again, mounting the electric conductor in a power connection port at the end portion of each of the dust collection plates, sequentially placing two end portions of the mold core into an adhesive injection container which is filled with the insulation adhesive, and dismantling the rod-shaped part after the insulation adhesive is cured.

This technical solution is further set as follows: the step S500 of mounting the electric conductor at the end portion of the mold core, and performing insulation treatment on the end portion of the mold core through the insulation adhesive specifically includes the following steps:
when the process hole is formed at an end portion of each of the dust collection plates, taking the rod-shaped part as the electric conductor, penetrating the rod-shaped part into the process hole again, sequentially placing two end portions of the mold core into an adhesive injection container which is filled with the insulation adhesive, and directly sealing the process hole after the insulation adhesive is cured.

This technical solution is further set as follows: the step S500 of mounting the electric conductor at the end portion of the mold core, and performing insulation treatment on the end portion of the mold core through the insulation adhesive specifically includes the following steps:
when the process hole is formed at an end portion of each of the dust collection plates, guiding the electric conductor by the rod-shaped part to penetrate into the process hole, sequentially placing two end portions of the mold core into an adhesive injection container which is filled with the insulation adhesive, and directly sealing the process hole after the insulation adhesive is cured.

This technical solution is further set as follows: isolation paper or an insulation thin layer is paved in the adhesive injection container.

The present invention has the following beneficial effects:
the electric conductor implements the electrical connection between the power supply and the dust collection plates, the fixed separator can improve the stability of the mold core, and the production process is perfected and simplified, thereby improving the production efficiency and reducing the input cost.

### BRIEF DESCRIPTION OF THE DRAWINGS

FIG. 1 is a flow block diagram of a production process for an electrostatic dust removal device according to an embodiment of the present invention;

FIG. 2 is a schematic diagram of a mold core according to an embodiment of the present invention;

FIG. 3 is an explosion view of a mold core according to an embodiment of the present invention;

FIG. 4 is a schematic diagram of an electrostatic dust removal device according to an embodiment of the present invention;

FIG. 5 is a side view of a dust collection plate according to an embodiment of the present invention;

FIG. 6 is a top view of a dust collection plate according to an embodiment of the present invention;

FIG. 7 is a top view of another implementation of a dust collection plate according to an embodiment of the present invention;

FIG. 8 is a schematic diagram of a dust collection plate seam of a dust collection plate according to an embodiment of the present invention;

FIG. 9 is a top view of another implementation of a dust collection plate according to an embodiment of the present invention;

FIG. 10 is a top view of another implementation of a dust collection plate according to an embodiment of the present invention;

FIG. 11 is a top view of another implementation of a dust collection plate according to an embodiment of the present invention;

FIG. 12 is a top view of another implementation of a dust collection plate according to an embodiment of the present invention.

### DETAILED DESCRIPTION OF THE EMBODIMENTS

To make those skilled in the art better understand the technical solutions of the present invention, the technical solutions of the present invention are clearly and completely described below with reference to the accompanying drawings of the present invention. Other embodiments obtained by a person of ordinary skill in the art based on the embodiments of the present application without creative efforts shall fall within the protection scope of the present application. In addition, the directional terms mentioned in the following embodiments, such as “up”, “down”, “left”, “right”, etc., are merely referring to the directions in the accompanying drawings. Therefore, the used directional terms are intended to illustrate rather than limit the present invention.

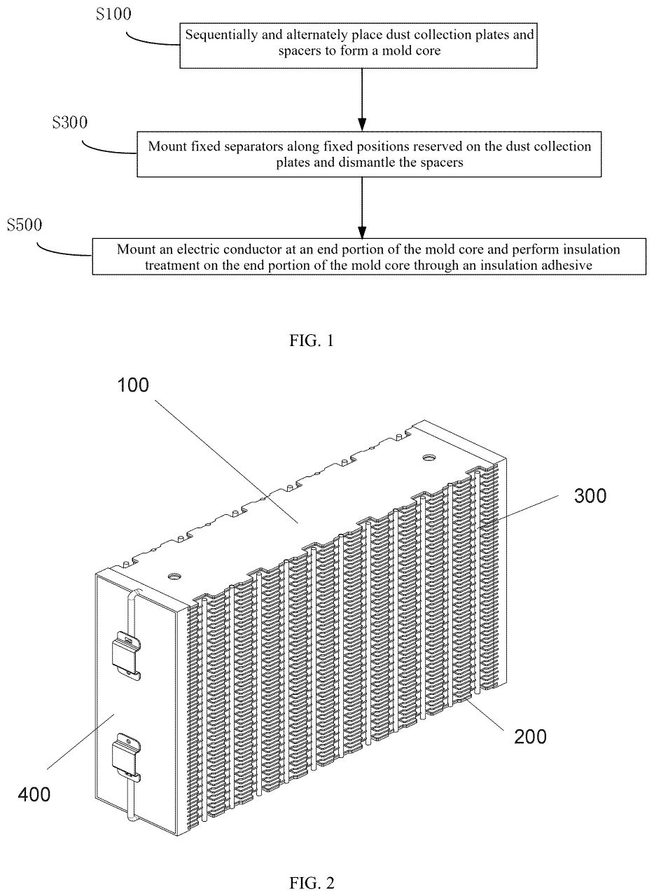

According to an embodiment of the present invention, a production process for an electrostatic dust removal device production is provided, referring to FIG. 1, including the following steps:
S100: dust collection plates and spacers are sequentially and alternately placed to form a mold core;
S300: fixed separators are mounted along fixed positions reserved on the dust collection plates, and the spacers are dismantled;
S500: an electric conductor is mounted at an end portion of the mold core, and insulation treatment is performed on the end portion of the mold core through an insulation adhesive.

It should be noted that the electric conductor implements the electrical connection between the power supply and the dust collection plates, the fixed separator can improve the stability of the mold core, and the production process is perfected and simplified, thereby improving the production efficiency and reducing the input cost.

According to the production process for the electrostatic dust removal device in this embodiment, referring to FIG. 1 to FIG. 3, in the step S100, the placing order of the dust collection plates 200 and the spacers is adjustable.

Specifically, the dust collection plates 200 include ground dust collection plates and high-voltage dust collection plates which are arranged in an alternately superimposed manner, the ground dust collection plates and the high-voltage dust collection plates are arranged in a 180° staggered manner, and the ground dust collection plates and the high-voltage dust collection plates have the same structure. The high-voltage dust collection plates are electrically connected to a high-voltage end of a power supply of the electrostatic dust removal device, and the ground dust collection plates are electrically connected to a low-voltage end of the power supply of the electrostatic dust removal device.

Preferably, the power supply of the electrostatic dust removal device may be arranged inside or outside.

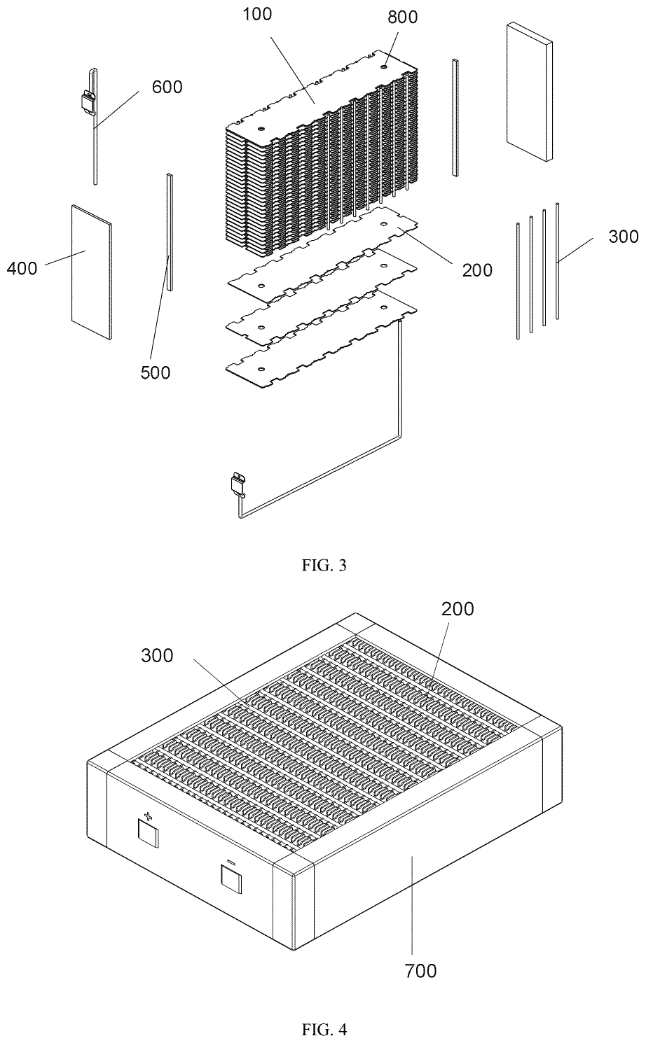

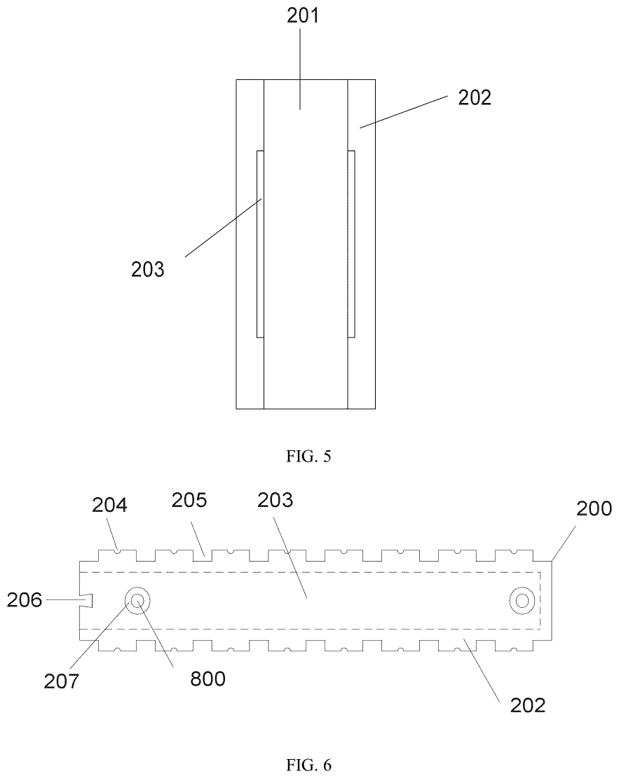

Referring to FIG. 3 and FIG. 5, an insulation layer 201 is arranged in a middle part of each of the dust collection plates 200, a semiconductor layer 202 is arranged on two sides of the insulation layer 201, and a conductive layer 203 is arranged between the insulation layer 201 and the semiconductor layer 202; meanwhile, adhesive layers are arranged between the semiconductor layer 202 and the conductive layer 203 as well as between the semiconductor layer 202 and the insulation layer 201.

It should be noted that the strength and stability of the dust collection plates 200 are improved by adding the insulation layer 201; and by adoption of the electrostatic dust removal device manufactured by the dust collection plates 200 with the structure, the stability of the device can be improved, the normal use of the device can be ensured, the space between the dust collection plates 200 can be effectively reduced, and the dust collection surface can be increased, thereby capturing more pollutants and improving the purification efficiency.

During production, the conductive layer 203, such as conductive ink, is symmetrically printed on the two sides of the flat insulation layer 201, the adhesive layer is coated after the conductive layer 203 is dried, the semiconductor layer is stuck or bonded on the adhesive layer, similarly, the semiconductor layer is stuck or bonded on the other side by the same method, and then the required dust collection plates are cut or punched on equipment.

Specifically, the conductive layer 203 is set as a long strip shape, which may be provided with one or more strips.

Specifically, the conductive layer 203 is made of a conductive material and an additive, the conductive material includes graphite, graphene or conductive printing ink, and the additive includes organosilicon, which can improve the heat resistance, water repellency and corona resistance of the materials.

The semiconductor layer 202 is made of a high polymer material and a heat conduction material, the high polymer material includes polyvinyl chloride, polyethylene, polypropylene, ABS plastic or polytetrafluoroethyleneone, and the heat conduction material includes one or more combinations of aluminium oxide, silicon dioxide, metal powder, silicon nitride, aluminium nitride, zinc oxide, calcium oxide, graphite and graphene. To achieve wide applicability while balancing production processing and material costs, polyethylene (abbreviated as PE) is preferred. Polyethylene has excellent low-temperature resistance and can maintain good mechanical properties even at −60° C. PE is odorless, tasteless, non-toxic, with a matte, milky white, waxy appearance. PE has the melting point ranging from 100° C. to 130° C., and is insoluble in water. PE remains flexible at low temperatures and has high electrical insulation and relatively high thermal conductivity.

The insulation layer 201 is made of one or more combinations of polypropylene, ABS plastic, polyamide, polyoxymethylene, polytetrafluoroethylene or polycarbonate. The insulation layer 201 is made of a rigid material. By virtue of its insulativity and supportability, the stiffness of the dust collection plates 200 is maintained. Polycarbonate is preferred, also known as PC plastic. The polycarbonate is colorless and transparent, heat-resistant, impact-resistant, has good mechanical properties, with a flame retardant grade BI, a melting point of 220° C. to 230° C., and possesses flame retardance and inoxidizability.

Specifically, the thickness of the insulation layer 201 is 0.1-1.0 mm, preferably 0.3 mm. If the insulation layer 201 is too thin, for example, less than 0.1 mm, the support strength is not enough and the dust collection plates are easy to deform; and if the insulation layer 201 is too thick, for example, greater than 1 mm, under the condition that the sizes of other layers are the same, the dust collection plates will be relatively thick, and the effective ventilation area per unit area of the corresponding purification and dust removal device will become smaller, and the purification efficiency and the dust holding capacity will be reduced. A range of 0.1-1 mm can balance the supportability and control of the thickness of the dust collection plates. The thickness of the semiconductor layer 202 is 0.05-0.5 mm, preferably 0.15 mm. If the semiconductor layer 202 is too thin, for example, less than 0.05 mm, it is difficult to process during production, and it is prone to damage during actual operation, affecting the stability; and if the semiconductor layer 202 is too thick, for example, greater than 0.5 mm, under the condition that the sizes of other layers are the same, the dust collection plates will be relatively thick, and the effective ventilation area per unit area of the corresponding purification and dust removal device will become smaller, and the purification efficiency and the dust holding capacity will be reduced. A range of 0.05-0.5 mm can balance the conductivity and control of the thickness of the dust collection plates. The thickness of the conductive layer 203 is 0.005-0.03 mm, preferably 0.01 mm.

Referring to FIG. 6, the length of the conductive layer 203 is less than that of the semiconductor layer 202, the conductive layer 203 extends to power connection ends of the dust collection plates, and the power connection ends are end portions of the power connection ports 206 of the dust collection plates. That is, one end portion of the conductive layer 203 is flush with the end portion of the semiconductor layer 202 to achieve the stable power connection, while the other end portion of conductive layer 203 is not flush with the end portion of the semiconductor layer 202.

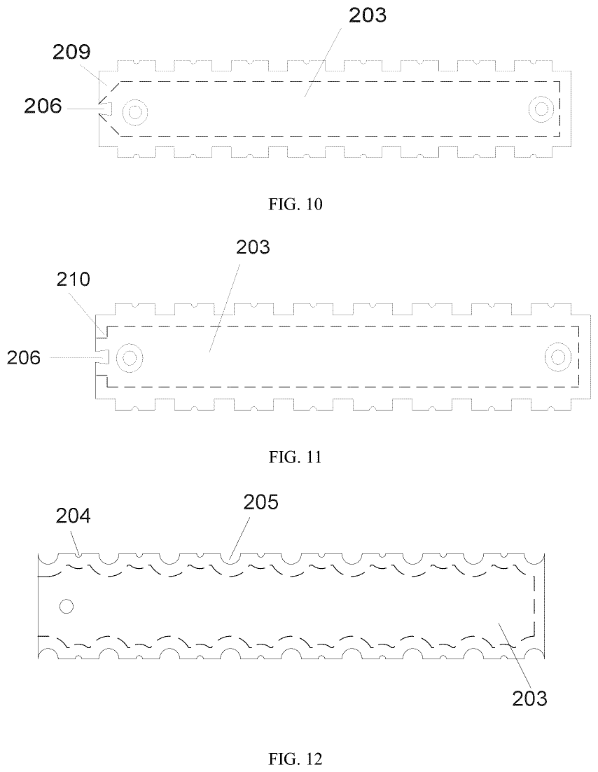

Referring to FIG. 10, the area of the end portion of the conductive layer 203 located at the power connection end is less than that of the other end portion of the conductive layer 203, and the area of the end portion of the conductive layer 203 located at the power connection end is reduced, so that the electrical safety distance between the end portion of the conductive layer 203 and the frame body of the electrostatic dust removal device can be prevented from being too close and avoid the influence on the stable operation in the later stage. Specifically, an end portion of the conductive layer 203 located at the power connection end is inclined towards a direction away from the power connection end from an entrance of the power connection port 206, a first electrical safety area 209 is present between the power connection end and the conductive layer 203, two first electrical safety areas 209 are symmetrically provided and the first electrical safety area 209 is triangular, and the symmetrical structural design can maintain the uniformity of the electrical safety distance.

Referring to FIG. 11, an end portion of the conductive layer 203 located at the power connection end is provided with a notch, the notch forms a second electrical safety area 210, two second electrical safety areas 210 are symmetrically provided and the second electrical safety areas 210 are square, and the symmetrical structural design can maintain the uniformity of the electrical safety distance. Specifically, the conductive layer 203 extends to an area between the notch and the power connection port 206.

Specifically, the thickness of the semiconductor layer of the dust collection layer dust collection plate is the same as that of the non-dust collection layer dust collection plate, which is conducive to processing and production.

It should be noted that the dust collection layers and non-dust collection layers of the dust collection plates are related to the high voltage supplied by the electrostatic dust removal device as well as the high voltage supplied by the front end ionization device. Specifically, the electrical voltage should be well designed at the beginning and the high-voltage power supply should be properly matched. Correspondingly, the dust collection plates can be matched during production. For example, if the ionization device is a direct-current positive high voltage, the particulate matter will carry a positive charge after passing through the ionization device. The dust collection plates of the electrostatic dust removal device are stacked in a staggered manner. The electricity supplied to one part of the dust collection plates is direct-current positive high voltage, and the other part of the dust collection plates is connected to the ground electrode. For the electrostatic dust removal device, the dust collection plates supplied with direct-current positive high voltage are the non-dust collection layer dust collection plates, and the dust collection plates connected to the ground are the dust collection layer dust collection plates.

Specifically, the thickness of the semiconductor layer of the dust collection layer dust collection plate is less than that of the non-dust collection layer dust collection plate.

It should be noted that on the premise of satisfying electrical safety, the thickness of the semiconductor layer of the dust collection layer dust collection plate is less than that of the non-dust collection layer dust collection plate. In the initial stage of operation, the amount of the particulate matters accumulated on the dust collection surface is limited and has no impact on the purification efficiency. As the operation time increases, the accumulation of the particulate matters increases and the thickness of the dust layer increases. The thinned semiconductor layer can quickly conduct away the charges of the particulate matter, avoiding the formation of the back corona phenomenon, and ensuring the purification efficiency.

To verify whether different thicknesses of the semiconductor layer on the dust collection surface and the non-dust collection surface have an impact on the purification efficiency of the electrostatic dust removal device, the inventors conducted the following experiments. The change in PM2.5 purification efficiency of the electrostatic dust removal device with a length of 500 mm, a width of 300 mm, and a thickness of 50.8 mm are compared during long-term operation of the electrostatic dust removal device, under the same ionization device and ionization voltage at the front end, and in the same environment at two different air velocities. The experimental data are shown in Table 1.

TABLE 1

| | Electrostatic Dust Removal Device | | | | | | | |
|---|---|---|---|---|---|---|---|---|
| | | | Thickness | Thickness | Thickness | Thickness | Thickness | Size of the |
| | | | of the | of the | of the | of the | of the | Electrostatic |
| | | Dust | Semiconductor | Conductive | Insulation | Conductive | Semiconductor | Dust Removal |
| Experimental | | Collection | Layer | Layer | Layer | Layer | Layer | Device |
| Scheme | No. | Plate | mm | mm | mm | mm | mm | mm |
| 1 | 1 | Dust collection | 0.2 | 0.02 | 0.2 | 0.02 | 0.2 | 500*300*50.8 |
| | | layer dust | | | | | | |
| | | collection plate | | | | | | |
| | | Non-dust | 0.2 | 0.02 | 0.2 | 0.02 | 0.2 | |
| | | collection layer | | | | | | |
| | | dust collection | | | | | | |
| | | plate | | | | | | |
| | 2 | Dust collection | 0.15 | 0.02 | 0.3 | 0.02 | 0.15 | 500*300*50.8 |
| | | layer dust | | | | | | |
| | | collection plate | | | | | | |
| | | Non-dust | 0.2 | 0.02 | 0.2 | 0.02 | 0.2 | |
| | | collection layer | | | | | | |
| | | dust collection | | | | | | |
| | | plate | | | | | | |
| 2 | 3 | Dust collection | 0.2 | 0.02 | 0.2 | 0.02 | 0.2 | 500*300*50.8 |
| | | layer dust | | | | | | |
| | | collection plate | | | | | | |
| | | Non-dust | 0.2 | 0.02 | 0.2 | 0.02 | 0.2 | |
| | | collection layer | | | | | | |
| | | dust collection | | | | | | |
| | | plate | | | | | | |
| | 4 | Dust collection | 0.15 | 0.02 | 0.3 | 0.02 | 0.15 | 500*300*50.8 |
| | | layer dust | | | | | | |
| | | collection plate | | | | | | |
| | | Non-dust | 0.2 | 0.02 | 0.2 | 0.02 | 0.2 | |
| | | collection layer | | | | | | |
| | | dust collection | | | | | | |
| | | plate | | | | | | |

| | Electrostatic Dust Removal Device | | | | | | |
|---|---|---|---|---|---|---|---|
| | Gap of | | | | Efficiency | Efficiency | Efficiency |
| | the Dust | | Surface | | in 15 | in 30 | in 45 |
| | Collection | Air | Air | Initial | days of | days of | days of |
| Experimental | Plate | Volume | Velocity | Efficiency | operation | operation | operation |
| Scheme | mm | m³/h | m/s | % | % | % | % |
| 1 | 1.5 | 1080 | 2 | 99 | 95 | 90 | 85 |
| | 1.5 | 1080 | 2 | 99 | 96 | 93 | 89 |
| 2 | 1.5 | 540 | 1 | 99 | 97 | 93 | 87 |
| | 1.5 | 540 | 1 | 99 | 97 | 95 | 91 |

From Table 1, it can be intuitively concluded that: when the thickness of the semiconductor layer on the dust collection surface is less than that on the non-dust collection surface, the thinner semiconductor layer on the dust collection surface is more conducive to the rapid transfer of the charges of the captured particulate matters. The back corona phenomenon is less likely to form, which is more conducive to ensuring the purification efficiency of the electrostatic dust removal device and increasing the dust holding capacity.

According to the production process for the electrostatic dust removal device of this embodiment, a conductive layer is arranged inside each of the dust collection plates, and a semiconductor layer is arranged on two sides of the conductive layer. Preferably, the conductive layer may be a metal material, such as an aluminum foil and a copper foil.

According to the production process for the electrostatic dust removal device of this embodiment, referring to FIG. 1, in the step S100, a rod-shaped part is used to sequentially penetrate into the dust collection plate and process holes in the spacers to form the mold core.

According to the production process for the electrostatic dust removal device of this embodiment, referring to FIG. 1 to FIG. 3, in the step S100, the rod-shaped part is used to sequentially penetrate through the insulation plates 100, the dust collection plates 200 and the process holes 800 in the spacers and is fastened outside the insulation plates 100 to form the mold core, thereby ensuring that the size of the mold core meets the design size.

During production, to improve the stability, the insulation plate 100 is first interwoven at the edge, the insulation plate 100 is made of an insulation material, the structure of the insulation plate 100 is similar to that of the dust collection plate 200, the thickness is set according to the strength requirement, and a plurality of insulation plates or a thicker insulation plate 100 is adopted. After the insulation plate 100 is interwoven, the dust collection plate 200, the spacer and the dust collection plate 200 are sequentially interwoven and alternately, and another insulation plate 100 is interwoven at the last edge. Or after the insulation plate 100 is interwoven, the spacer, the dust collection plate 200 and the spacer are sequentially interwoven and alternately, and another insulation plate 100 is interwoven at the last edge.

It should be noted that the insulation plate 100 may be an insulation rigid plate, with high stability. The insulation plate 100 may be an insulation flexible plate, which is convenient to assemble.

According to the production process for the electrostatic dust removal device of this embodiment, referring to FIG. 1 to FIG. 3, in the step S300, the insulation adhesive is poured along the fixed positions 204 reserved on the dust collection plates 200, that is, the insulation adhesive serves as a fixed separator 300, and the fixed positions 204 are arranged at the edges of the dust collection plates 200.

Specifically, referring to FIG. 6, the fixed positions 204 are semicircular openings, and the cured insulation adhesive is flush with the edges of the dust collection plates 200 or protrudes from the edges of the dust collection plates 200. In some other embodiments, the fixed positions 204 may be slotted openings, and the cured insulation adhesive is flush with the edges of the dust collection plates 200 or protrudes from the edges of the dust collection plates 200. The design of the semicircular openings and the avoiding port 205 form an equidistant safety distance, and an approximate circular colloid is formed after gluing and fixation. Meanwhile, the diameter of the semicircular opening is adapted to the adhesive quantity, and when the cured insulation adhesive is flush with the edges of the dust collection plates 200, the surface flatness and aesthetics can be maintained.

After filling the shallow arc opening with the insulation adhesive to fix, an approximately circular colloid is formed, and an equidistant safety distance is formed between the circular colloid and the avoiding port 205, at the same time, a size of the shallow arc opening is adapted to the adhesive quantity, the colloid is flush with an edge of the dust collection plate or slightly lower than an edge of the dust collection plate, i.e., a part of the colloid is in the shallow arc opening, and a part of the colloid is combined with the dust collection plate to form an approximately circular colloid and maintain the surface flatness and aesthetics. Alternatively, the fixed positions 204 are semicircular openings, the avoiding port 205 is a deep arc opening, and after filling the semicircular opening with the insulation adhesive to fix, an approximately circular colloid is formed, and an equidistant safety distance is formed between the circular colloid and the avoiding port 205, at the same time, a size of the semicircular opening is adapted to the adhesive quantity, the colloid is flush with an edge of the dust collection plate or slightly lower than an edge of the dust collection plate after gluing, i.e., a part of the colloid is in the semicircular opening, and a part of the colloid is combined with the dust collection plate to form an approximately circular colloid and maintain the surface flatness and aesthetics. The equidistant safety distance design utilizes the natural settling of the insulation adhesive, as well as the bonding of the insulation adhesive and the dust collection plate to form the approximately circular colloid, mainly including the two forms mentioned previously; the equidistant safety distance design can improve the proportion of the conductive layer of the dust collection plate as much as possible, thereby improving the purification efficiency and the dust holding capacity of the electrostatic dust removal device, and prolonging the maintenance cycle; and the design of the equidistant safety distance is such that in the later stage of the operation of the electrostatic dust removal device, a layer of dust will adhere to the colloid surface and the dust collection surface. When encountering high humidity and other environments, the dust will have a certain conductivity, which will indirectly reduce the safety distance of the electrostatic dust removal device. At this point, the dust collection plates and colloids connected to different potential voltages will generate leakage current due to the reduction of the electrical safety distance, thereby reducing the purification efficiency of the electrostatic dust removal device and shortening the maintenance cycle.

During production, after the interweaving process is completed, the mold core is formed, and correction is performed through a right-angled tool. At this time, gluing and fixation are performed along the fixed positions 204, and gluing may be performed by an automatic process or adopt a manual gluing method. The insulation adhesive has high adhesive strength and is resistant to high and low temperature impacts, such as the commercially available PUR glue; It is also possible to use hot melt adhesive for fixation. However, the electrostatic dust removal device fixed with hot melt adhesive has limited application fields, and cannot be used in environments with large temperature differences throughout the year or between morning and evening. The hot melt adhesive is prone to become soft when exposed to high temperatures and embrittle when exposed to low temperatures. After one side surface of the mold core is glued and cured, flipped and checked by the right-angled tool, thereby preventing deviation. After checking by the right-angled tool, the other side surface of the mold core is glued and fixed along the fixed positions 204. Generally, the gravity is used to perform gluing and fixation above the mold core.

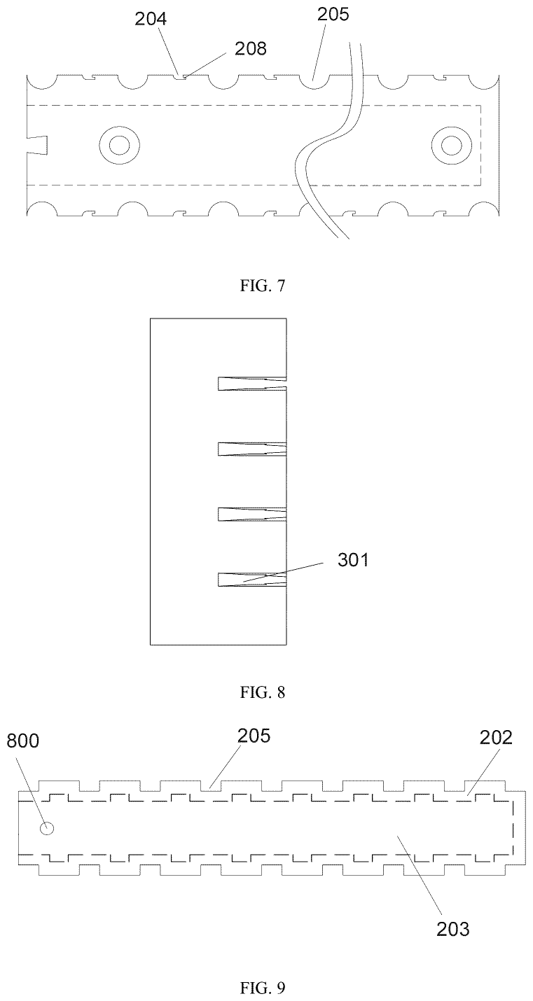

In addition, referring to FIG. 7, grooves 208 facing the avoiding port 205 are formed inside the fixed positions 204, the grooves 208 increase the contact area of the fixed positions 204 and the colloid, vertical gluing can be implemented, vertical gluing can be performed on two surfaces at the same time, and the production speed is higher. The design of the grooves 208 allows more colloids to penetrate into the grooves 208 during vertical gluing, forming a bonding between the colloid and the dust collection plate in the grooves 208, with a larger contact area and better firmness.

According to the production process for the electrostatic dust removal device of this embodiment, referring to FIG. 1 to FIG. 3 and FIG. 8, in the step S300, rigid insulation parts are mounted along the fixed positions 204 reserved on the dust collection plates 200, that is, the rigid insulation parts serve as the fixed separators 300, and the rigid insulation parts are provided with dust collection plate seams 301 for accommodating the dust collection plates 200.

It should be noted that at the point where the rigid insulators are in contact with the dust collection plates 200, the width of the rigid insulators in the length direction of the dust collection plates 200 is increased; meanwhile, the rigid insulators are provided with dust collection plate seams 301 for better clamping the dust collection plates 200, thereby increasing the fixed contact area of the dust collection plates 200 and ensuring the stability of the spacing between the dust collection plates 200.

In addition, the rigid insulator may be mounted on one side surface of a model, and the insulation adhesive may be poured in the other side surface of the model. In some other embodiments, the insulation adhesive may also be poured for fixation after the dust collection plates 200 are clamped by the rigid insulators, thereby improving the stability.

Specifically, the dust collection plate seams 301 are set as necked receiving structures (that is, the size of the opening parts of the dust collection plate seams 301 is less than the internal size), and a prestress is preset after the dust collection plates 200 are clamped, thereby improving the fixing strength. In addition, the dust collection plate seams 301 are set as anti-slip structures (that is, inner walls of the dust collection plate seams 301 are non-smooth surfaces, and anti-slip protrusions or anti-slip teeth are arranged on the inner walls), and the dust collection plates 200 are not easy to loose after being clamped; meanwhile, the anti-slip structures can reduce the use quantity of the insulation adhesive as much as possible. It should be noted that it is unnecessary to set all the dust collection plate seams 301 as the anti-slip structures, and the dust collection plate seams may be arranged at intervals, that is, part of the dust collection plate seams 301 are the anti-slip structures.

According to the production process for the electrostatic dust removal device in this embodiment, referring to FIG. 1 to FIG. 3, in the step S300, the rod-shaped part is dismantled, and the spacers are withdrawn from the end portion of the mold core.

It should be noted that the rod-shaped part may be a metal part, or may be a non-metal part, requiring better rigidity. The rod-shaped part is required to be matched with the process hole 800 better, the diameter of the rod-shaped part is less than that of the process hole 800, and the gap is 0.5±0.1 mm, thereby ensuring the structural shape of the mold core.

Meanwhile, the width of the spacer is less than that of the dust collection plate 200, and the length of the spacer is less than that of the dust collection plate 200, thereby facilitating disassembling. The spacers have the identical size and can have different thicknesses to adapt to the design requirement of the gap between the dust collection plates. In general, when the insulation adhesive serves as the fixed separator 300, the gap between the dust collection plates is 0.5-3 mm. When the rigid insulation part is the fixed separator 300 or the rigid insulation part is combined with the insulation adhesive, the gap between the dust collection plates may be larger.

According to the production process for the electrostatic dust removal device in this embodiment, referring to FIG. 1 to FIG. 6, in the step S500, an electric conductor 500 is mounted at the end portion of the mold core, and insulation treatment is performed on the end portion of the mold core through the insulation adhesive to form the insulation adhesive layer 400, specifically as follows:
when the process holes 800 are formed at the two end portions of the dust collection plates 200, and insulation gaps 207 are formed between the process holes 800 and the conductive layer 203 to form the safety distance, and the production process is tedious. To maintain the stability of the mold core, the rod-shaped part penetrates into the mold core along the process holes 800 again after the spacers are dismantled, and at this time, the displacement and loose phenomena of the model are avoided through the stable structure formed by the rod-shaped part and the fixed separator 300. The electric conductor 500 is mounted in the power connection port 206 at the end portion of the dust collection plate 200, the two end portions of the mold core are sequentially placed in the adhesive injection container which is filled with the insulation adhesive, and the rod-shaped part is dismantled after the insulation adhesive is cured.

It should be noted that after assembling, the insulation adhesive layer 400 directly seals the process holes 800 and the power connection port 206, but part of the process holes 800 are in a bare state after the rod-shaped part is dismantled. In the operation process of the electrostatic dust removal device, part of the process holes 800 in the bare state are easy to form a purification blind area.

Specifically, the power connection port 206 adopts a necked receiving structure, the electric conductor 500 is inserted into the power connection port 206 to achieve power connection, and the power connection port 206 with the necked receiving structure forms an inward action for to the electric conductor 500, resulting in a higher fitness between the electric conductor 500 and the conductive layer 203.

Preferably, referring to FIG. 6, the power connection port 206 with the necked receiving structure includes an opening end and a closed end, a protruding end is arranged between the opening end and the closed end, and the electric conductor 500 enters the power connection port 206 from the opening end. According to the power connection port 206 with the necked receiving structure, the upper bottom of the isosceles trapezoid serves as the opening end, the lower bottom of the isosceles trapezoid serves as the closed end, and the lateral sides of the isosceles trapezoid serves as the protruding end. By using the protruding end to exert an inward force on the electric conductor 500, the power connection port 206 is clamped with the electric conductor 500. Preferably, the included angle between the protruding end and the horizontal direction is 10° to 25°. When the included angle is less than 10°, the power connection port 206 is more prone to be clamped with the electric conductor 500, with poor firmness after clamping. When the included angle is greater than 25°, the power connection port 206 is more difficult to be clamped with the electric conductor 500, with better firmness after clamping. When the included angle is equal to 15°, the power connection port 206 is more prone to be clamped with the electric conductor 500, with better firmness after clamping. In addition, an arc matched with the electric conductor 500 can be arranged at the protruding end, such that the electric conductor 500 partially falls into the arc after being clamped into the power connection port 206, making the clamping tighter.

In some other embodiments, the cross-section of the power connection port 206 with the necked receiving structure is circular arc-shaped, and the contact area between the circular arc and the electric conductor 500 increases, resulting in better power connection stability. Preferably, the circular arc is a major arc. The diameter of the electric conductor 500 is matched with the circular arc, with a gap of 0.2-1 mm. When the gap is less than 0.2 mm, the gap between the electric conductor 500 and the circular arc is too small to clamp easily, and the requirement of the manufacturing process is too high. When the gap is greater than 1 mm, the gap between the electric conductor 500 and the circular arc is excessive, resulting in loosing after clamping and poor power connection stability.

According to the production process for the electrostatic dust removal device in this embodiment, refer to FIG. 1 to FIG. 5 and FIG. 9, in the step S500, an electric conductor 500 is installed at the end portion of the mold core, and insulation treatment is performed on the end portion of the mold core through the insulation adhesive to form the insulation adhesive layer 400, specifically as follows:
when the process hole 800 is formed at an end portion of the dust collection plate 200, the spacing between the process hole 800 and the end portion of the dust collection plate 200 is 2-5 mm, the processing hole 800 also functions as the power connection port, and at this time, it is unnecessary to set an insulation gap between the process hole 800 and the conductive layer 203, thereby reducing the processing difficulty. The rod-shaped part serves as the electric conductor 500, the rod-shaped part penetrates into the mold core along the process holes 800 again after the spacers are dismantled, and at this time, the displacement and loose phenomena of the model are avoided through the stable structure formed by the rod-shaped part and the fixed separator 300. The two end portions of the mold core are sequentially put into the adhesive injection container which is filled with the insulation adhesive, the process hole 800 is directly sealed after the insulation adhesive is cured, and it is unnecessary to dismantle the rod-shaped part again, thereby simplifying the production process.

It should be noted that the rod-shaped part as the electric conductor 500 is present in the process hole 800, and after assembling, the insulation adhesive layer 400 directly seals the process hole 800 and the power connection port 206, that is, the process hole 800 and the power connection port 206 are covered, thereby solving the problem of the purification blind area.

Specifically, the spacings between the edge of the conductive layer 203 as well as the fixed positions 204 and the avoiding port 205 are equal, the edge shape of the conductive layer 203 is designed according to the shapes for the fixed positions 204 and the avoiding port 205, so that the proportion of the conductive layer 203 is maximally increased, the electrical safety is not affected, the area of capturing the particulate matters by the electrostatic dust removal device is increased, the action time on the particular matters is prolonged, the purification efficiency of the particular matters is improved, and the dust holding capacity of the electrostatic dust removal device is correspondingly increased. Referring to FIG. 12, the reserved fixed positions 204 and the avoiding port 205 are semicircular openings; therefore, the edge of the conductive layer 203 resembles wavy. Referring to FIG. 9, the avoiding port 205 are slotted openings; therefore, the edge of the conductive layer 203 resembles rectangular teeth.

To verify whether different shapes of conductive layers 203 have an impact on the purification efficiency of the electrostatic dust removal device, the inventors conducted the following experiments. The PM2.5 purification efficiency of the electrostatic dust removal device with a length of 500 mm, a width of 400 mm, and a thickness of 50.8 mm are compared, under the same ionization device and ionization voltage at the front end, and in the same environment at two different air velocities. The experimental data are shown in Table 2.

TABLE 2

| | | Size of the | Gap of the | | | |
|---|---|---|---|---|---|---|
| | Shape of | Electrostatic | Dust | | Surface | PM2.5 |
| | the Dust | Dust Removal | Collection | Air | Air | Purification |
| Experimental | Collection | Device | Plate | Volume | Velocity | Efficiency |
| Scheme | Plate | mm | mm | m³/h | m/s | % |
| 1 | Waveform | 500*400*50.8 | 1.5 | 2160 | 3 | 98 |
| | Square | 500*400*50.8 | 1.5 | 2160 | 3 | 97 |
| | Common | 500*400*50.8 | 1.5 | 2160 | 3 | 93 |
| 2 | Waveform | 500*400*50.8 | 1.5 | 2880 | 4 | 96 |
| | Square | 500*400*50.8 | 1.5 | 2880 | 4 | 93 |
| | Common | 500*400*50.8 | 1.5 | 2880 | 4 | 86 |

From Table 2, it can be concluded that: the conductive layer 203 of the waveform (referring to FIG. 12) has the maximum proportion, and its PM2.5 purification efficiency is maximum at two different air velocities; the proportion of the conductive layer 203 in the square shape (referring to FIG. 9) is second only to the waveform, and the PM2.5 purification efficiency is also relatively high; and when the high air velocity is 4 m/s, the proportion of the ordinary (referring to FIG. 6) conductive layer 203 is the minimum, and its efficiency has the largest and most significant difference from waveforms and squares. Therefore, increasing the proportion of the conductive layer 203 is beneficial to ensuring the PM2.5 purification efficiency of the electrostatic dust removal device, and the improvement in efficiency will also correspondingly increase the dust holding capacity of the electrostatic dust removal device.

According to the production process for the electrostatic dust removal device in this embodiment, refer to FIG. 1 to FIG. 5 and FIG. 9, in the step S500, an electric conductor 500 is installed at the end portion of the mold core, and insulation treatment is performed on the end portion of the mold core through the insulation adhesive to form the insulation adhesive layer 400, specifically as follows:
when the process hole 800 is formed at an end portion of the dust collection plate 200, the spacing between the process hole 800 and the end portion of the dust collection plate 200 is 2-5 mm, the processing hole 800 also functions as the power connection port, and at this time, it is unnecessary to set an insulation gap between the process hole 800 and the conductive layer 203, thereby reducing the processing difficulty. The rod-shaped part penetrates into the mold core along the process hole 800 again after the spacers are dismantled; meanwhile, the rod-shaped rod guides the electric conductor 500 to penetrate into the process hole 800, two end portions of the mold core are sequentially placed into the adhesive injection container which is filled with the insulation adhesive, and the process hole 800 is directly sealed after the insulation adhesive is cured.

It should be noted that the electric conductor 500 is present in the process hole 800, and after assembling, the insulation adhesive layer 400 directly seals the process hole 800 and the power connection port 206, that is, the process hole 800 and the power connection port 206 are covered, thereby solving the problem of the purification blind area.

Specifically, isolation paper or an insulation thin layer is paved in the adhesive injection container.

During production, the end portion of the mold core with the electric conductor 500 is put into the adhesive injection container, the electric conductor 500 is tightened and cannot be loosened, and then the insulation adhesive is poured slowly, such as epoxy resin adhesive and silica gel. Or according to the use amount of the insulation adhesive of each mold core, the insulation adhesive may be poured first and then be slowly put into the end portion of the mold core. After the insulation adhesive at the end portion of the mold core is cured, the other end portion of the mold core is cured by the same method.

It should be noted that the height of the insulation adhesive is 3-5 mm higher than the electric conductor before curing. The height of the insulation adhesive layer 400 is 2-4 mm higher than the electric conductor after curing. Different insulation adhesives have different shrinkage rates, and an appropriate height is controlled according to the insulation requirements. Meanwhile, the ground dust collection plates and the high-voltage dust collection plates are arranged in a staggered manner, so that gaps are present between the end portions of the ground electrode plates and the high-voltage electrode plates, and the insulation adhesive layer 400 does not cover or cover the gaps.

According to the production process for the electrostatic dust removal device of this embodiment, referring to FIG. 1 to FIG. 4, the mold core subjected to insulation treatment is put into the frame body 700, and at the same time, the electric conductor 500 is electrically connected to the frame body 700 through a wire 600. In addition, a high-voltage power supply is arranged inside or outside the frame body 700, that is, the high-voltage power supply may be arranged inside or outside.

The present invention has been described in detail above, and the above is only a preferred embodiment of the present invention and is not intended to limit the implementation scope of the present invention, i.e. all equivalent variations and modifications made within the claims of the present invention shall be included within the scope of the present invention.

What is claimed is:

1. A production process for an electrostatic dust removal device, comprising the following steps:
S100: sequentially and alternately placing dust collection plates and spacers to form a mold core;
S300: mounting fixed separators along fixed positions reserved on the dust collection plates, and dismantling the spacers; and
S500: mounting an electric conductor at an end portion of the mold core, and performing insulation treatment on the end portion of the mold core through an insulation adhesive.

2. The production process for an electrostatic dust removal device according to claim 1, wherein in the step S100, the placing order of the dust collection plates and the spacers is adjustable, the dust collection plates comprise ground dust collection plates and high-voltage dust collection plates which are arranged in an alternately superimposed manner, the ground dust collection plates and the high-voltage dust collection plates are arranged in a 180° staggered manner, and the ground dust collection plates and the high-voltage dust collection plates have the same structure.

3. The production process for an electrostatic dust removal device according to claim 1, wherein an insulation layer is arranged inside each of the dust collection plates, a semiconductor layer is arranged on two sides of the insulation layer, and a conductive layer is arranged between the insulation layer and the semiconductor layer.

4. The production process for an electrostatic dust removal device according to claim 3, wherein a manufacturing method for each of the dust collection plates comprises the following steps:
symmetrically printing the conductive layer on the two sides of the insulation layer, coating an adhesive layer after the conductive layer is dried, sticking or bonding the semiconductor layer on the adhesive layer, sticking or bonding the semiconductor layer on the conductive layer on the other side by the same method after flipping, and cutting or punching the dust collection plates meeting the design size requirements on equipment.

5. The production process for an electrostatic dust removal device according to claim 3, wherein the thickness of the semiconductor layer of a dust collection layer dust collection plate is less than that of the non-dust collection layer dust collection plate.

6. The production process for an electrostatic dust removal device according to claim 1, wherein a conductive layer is arranged inside each of the dust collection plates, and a semiconductor layer is arranged on two sides of the conductive layer.

7. The production process for an electrostatic dust removal device according to claim 2, wherein in the step S100, a rod-shaped part is used to sequentially penetrate into the dust collection plate and process holes in the spacers to form the mold core.

8. The production process for an electrostatic dust removal device according to claim 7, wherein in the step S100, insulation plates are arranged on two side surfaces of the mold core, the rod-shaped part is used to sequentially penetrate into the insulation plates, the dust collection plates and the process holes in the spacers and is fastened outside the insulation plates to form the mold core.

9. The production process for an electrostatic dust removal device according to claim 1, wherein in the step S300, insulation adhesives are poured along the fixed positions reserved on the dust collection plates, and the fixed positions are arranged on edges of the dust collection plates.

10. The production process for an electrostatic dust removal device according to claim 1, wherein in the step S300, rigid insulation parts are mounted along the fixed positions reserved on the dust collection plates, and dust collection plate seams for accommodating the dust collection plates are formed in the rigid insulation parts.

11. The production process for an electrostatic dust removal device according to claim 9, wherein in the step S300, a rod-shaped part is dismantled, and the spacers are withdrawn from the end portion of the mold core.

12. The production process for an electrostatic dust removal device according to claim 7, wherein the step S500 of mounting the electric conductor at the end portion of the mold core, and performing insulation treatment on the end portion of the mold core through the insulation adhesive specifically comprises the following steps:
when the process holes are formed in two end portions of each of the dust collection plates, penetrating the rod-shaped part into the process holes again, mounting the electric conductor in a power connection port at the end portion of each of the dust collection plates, sequentially placing two end portions of the mold core into an adhesive injection container which is filled with the insulation adhesive, and dismantling the rod-shaped part after the insulation adhesive is cured.

13. The production process for an electrostatic dust removal device according to claim 7, wherein the step S500 of mounting the electric conductor at the end portion of the mold core, and performing insulation treatment on the end portion of the mold core through the insulation adhesive specifically comprises the following steps:
when the process hole is formed at an end portion of each of the dust collection plates, taking the rod-shaped part as the electric conductor, penetrating the rod-shaped part into the process hole again, sequentially placing two end portions of the mold core into an adhesive injection container which is filled with the insulation adhesive, and directly sealing the process hole after the insulation adhesive is cured.

14. The production process for an electrostatic dust removal device according to claim 7, wherein the step S500 of mounting the electric conductor at the end portion of the mold core, and performing insulation treatment on the end portion of the mold core through the insulation adhesive specifically comprises the following steps:
when the process hole is formed at an end portion of each of the dust collection plates, guiding the electric conductor by the rod-shaped part to penetrate into the process hole, sequentially placing two end portions of the mold core into an adhesive injection container which is filled with the insulation adhesive, and directly sealing the process hole after the insulation adhesive is cured.

15. The production process for an electrostatic dust removal device according to claim 12, wherein isolation paper or an insulation thin layer is paved in the adhesive injection container.
